(19) United States
(12) Patent Application Publication
(10) Pub. No.: US 2006/0074854 A1
(43) Pub. Date: Apr. 6, 2006

(54) Innovative product design using application trees

(76) Inventor: Gosakan Aravamudan, Bangalore (IN)

Correspondence Address: Ashok Tankha;Lipton Weinberger & Husick, 201 North Jackson Street, P.O. Box 934, Media, PA, 19063, US

(21) Appl. No.: 10/957,906

(22) Filed: Oct. 4, 2004

(51) Int. Cl. G06F 17/30

(52) U.S. Cl. 707/2

(57) ABSTRACT

This invention discloses a computer-based method for identifying components to build products and for identifying new applications of a component or product to enable cross-industry marketing of that component or product. The method comprises the following steps: implement product, component and application extraction logic functions to differentiate and classify the claims in patent documents into product claims and process claims; segment a product claim into a product, component and application sections and extract product, component and their application information and create a product application database; conduct a search in the product application database to determine a set of product records containing, product, component and application information; focus the search by input of available information on the product, application and component; and rank resulting records comprising the unmet products, components and applications.

### BACKGROUND OF THE INVENTION

This invention relates in general to a knowledge management system and relates specifically to a product design tool.

Identification of suitable components and systems to meet design criteria and to satisfy unmet application needs in the product design process is a time consuming activity for the product design team. In the conventional product design process, a scientist with domain expertise in a particular technology area designs a product to address the unmet application or need. However, the best component that meets the application might not necessarily reside in or evolve from the technology sector in which the scientist has expertise. This invention, in part, addresses and identifies components and also the optimum component from the entire technology spectrum to meet the component, application or product need.

Also, modification of components, systems, or a product in a certain industry may allow the use of that component, system or product in another related or non-related industry to satisfy an entirely different application or need. This invention allows designers, product managers and marketers to more efficiently search for new components or systems for their application requirements and also to search for cross-industry use or applications for their components or products.

Typically, when a designer needs to identify and design a component for a particular application, the designer itemizes all the component options that the designer is aware of that meet the application requirements, and thereafter selects the most appropriate component. It is unrealistic to expect a marketer or a designer at ABC Company to have knowledge of the applications of a particular component or system across other industries.

By way of example, consider a semiconductor manufacturer ABC Company who manufactures an Indium Gallium Arsenide (InGaAs) semiconductor chip used for light detection, and sells receivers containing the InGaAs chips to fiber-optic customers in the telecommunications industry. Assume that the demand for fiber-optic telecommunication equipment has fallen and ABC Company is unable to find customers for its packaged InGaAs chips in the telecommunications industry. The marketers and designers of ABC Company have a strong understanding of the application of the InGaAs chip in the telecommunications industry, but are unaware of the possible applications of the InGaAs chip in the defense, automotive or medical industries. In the defense industry, InGaAs chips are used as sensors in the tail wings of fighter aircrafts. In the automotive industry, InGaAs chips are used in the communication system of high end and light-weight car models. In the medical industry, InGaAs chips are used in optical sensing of high throughput screening applications. There are many additional applications for the InGaAs material in other industries, for example use of InGaAs chips in historic material conservation, ice detection in aircraft wings, camouflage detection in warfare and semiconductor wafer inspection. This invention allows the designer and marketing person at ABC Company to conduct a cross-industry search for components and also a search for applications for ABC Company's components and products.

Consider the downstream end of a design process, for example where a medical device firm DEF Company in the area of high throughput screening is looking for a component to determine loss in the intensity of light after the passage of the light through a liquid medium. The firm is looking for the ideal component for such a light detection application. The designers of DEF Company are probably aware of one or two components that meet the light detection application such as the use of an Indium Gallium semiconductor chip. However, the optimum solution could be any of the following components: InGaAs chips, Indium Gallium (InGa) chips, or Indium Phosphide (InP) semiconductor chips. This invention allows the selection of the optimum chip for DEF Company's application.

Currently there are no knowledge management software tools available for comprehensively and accurately identifying potential components in all technology sectors to meet the need for a given application. Neither is a knowledge management software tool available that can comprehensively identify applications in all technology sectors for a given component.

The available knowledge management software solutions focus on generating synonyms and identifying word relationships for the component or application to be identified. A visual map of related words assists the designer in thinking out of the box. Results are presented in an interactive visual map. Random words are generated to stimulate the thinking process. Words and phrases and colloquialisms are combined to stimulate non-linear thought. In some cases, a set of leading questions are asked and the response to the question advances the process a step further in the selection of a component, development of the product, or creation of new idea. Current solutions provide a synonym list tailored to specific technical fields, such as the aerospace, automotive, biotechnology, manufacturing, and pharmaceutical industries.

The conventional solutions today provide support for lateral thinking, or out of the box thinking through synonym generation, but are not comprehensive and rarely provide focused results. There is an unsatisfied need for a tool that provides comprehensive and accurate component or system identification and selection alternatives for a given application, and a tool to allow cross-industry marketing of a component, product or application. There is also an unsatisfied need for a tool that provides comprehensive and accurate application alternatives for a given component.

### SUMMARY OF THE INVENTION

In this invention, product and application information from published patents is extracted and stored in a patent application database. At present, more than approximately 15 million patents have been published worldwide. On an average, if approximately 10 product component and application records are extracted from a patent document, a total of 150 million product component and application records may be populated in the patent application database contained in the product application design (PAD) tool. This is an invaluable source of information for product designers and marketers. For example, the designers and marketers of ABC Company described in the background section above can identify approximately 20 applications for InGaAs chips using the PAD tool.

In this invention, the assignee, inventor and patent number correlating to each record containing product, component and application information are also extracted from the patent documents and stored in the product application database. The stored information is then matched with the product designer's requirement parameters for the component or product or used for purposes of cross-industry marketing of that component or product.

This invention also discloses a method of identifying multiple components or systems that solves a given application.

This invention also discloses a method of identifying multiple applications for a given component or system.

This invention also discloses a method of focusing the area of search for a component or application by input of known components or known applications and focusing in on a particular industry.

This invention also discloses a method of ranking the component, product or application results using information on the known components or known application and industry focus.

A more complete understanding of the present invention, as well as further features and advantages of the present invention will be obtained by reference to the following detailed description and drawings.

### BRIEF DESCRIPTION OF THE DRAWINGS

FIG. 1 illustrates a conceptual tree of the relationship between products, components and applications.

FIG. 2 illustrates the contents of each node of the conceptual tree of FIG. 1.

FIG. 3 illustrates the input user interface of the product application design (PAD) tool.

FIG. 4 illustrates the output user interface of the product application design (PAD) tool.

FIG. 5 illustrates the architecture of the PAD tool. The embodiment of the PAD tool shown in FIG. 5 does not contain a database of patents.

FIG. 6 illustrates the architecture of the PAD tool. The embodiment of the PAD tool shown in FIG. 6 contains a database of patents.

FIG. 7A illustrates the method for searching the claims of the patents using international patent classification codes.

FIG. 7B illustrates the method for searching the claims in a patent document.

FIG. 8 illustrates the method of extracting information from a patent document, culminating in the creation of the product application database.

FIG. 9 illustrates the method of ranking the search results and eliminating undesired outputs.

FIG. 10A illustrates the logic and algorithms used to extract component and application information from the claims section of patents.

FIG. 10B illustrates the logic and algorithms used to extract component and application information from the claims section of patents.

### DETAILED DESCRIPTION OF THE INVENTION

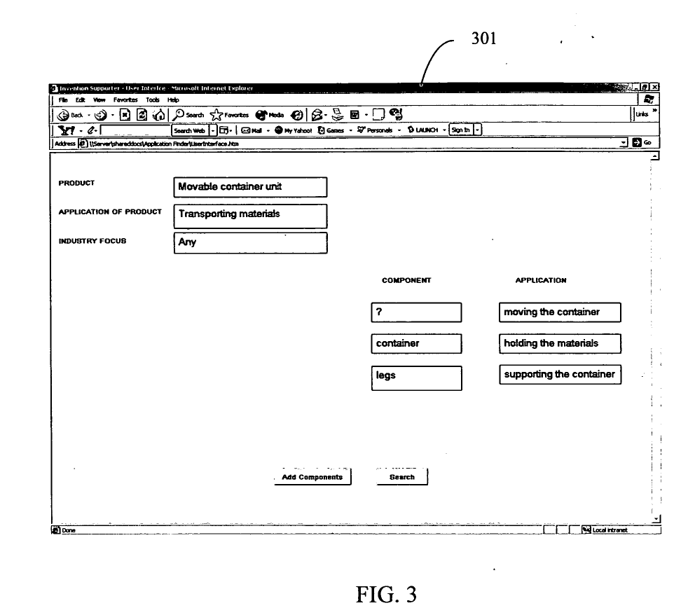

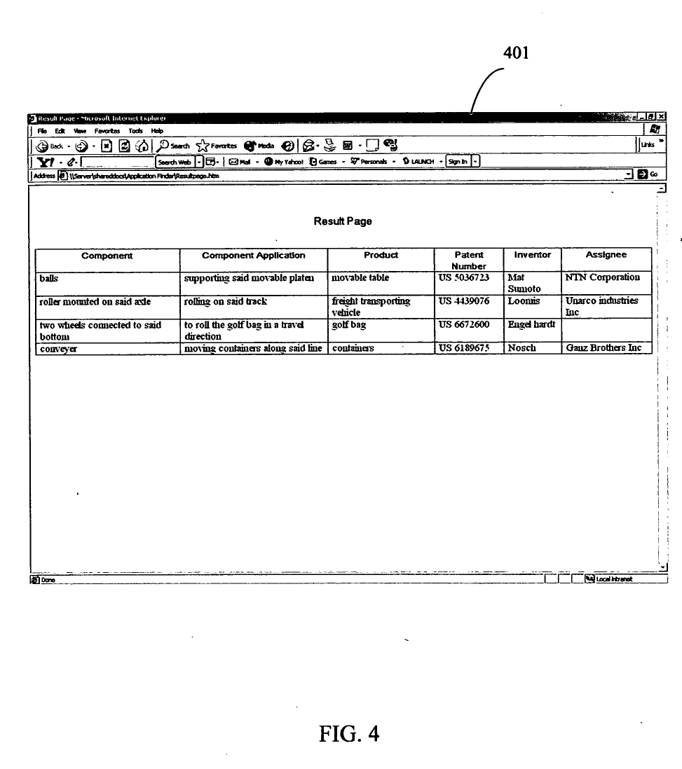

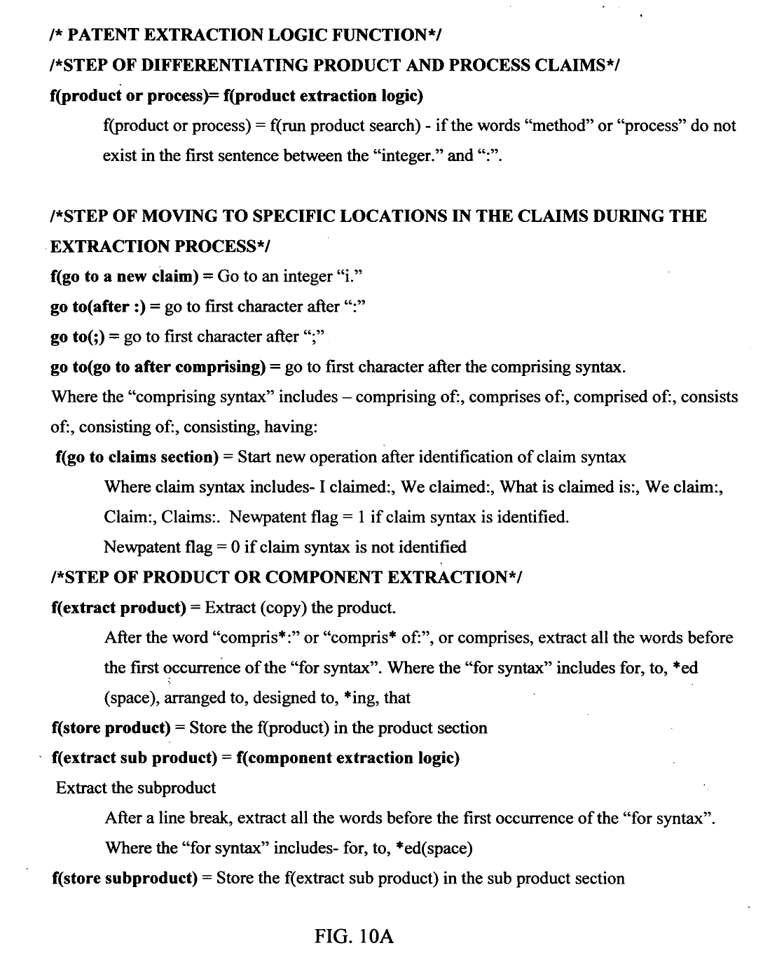

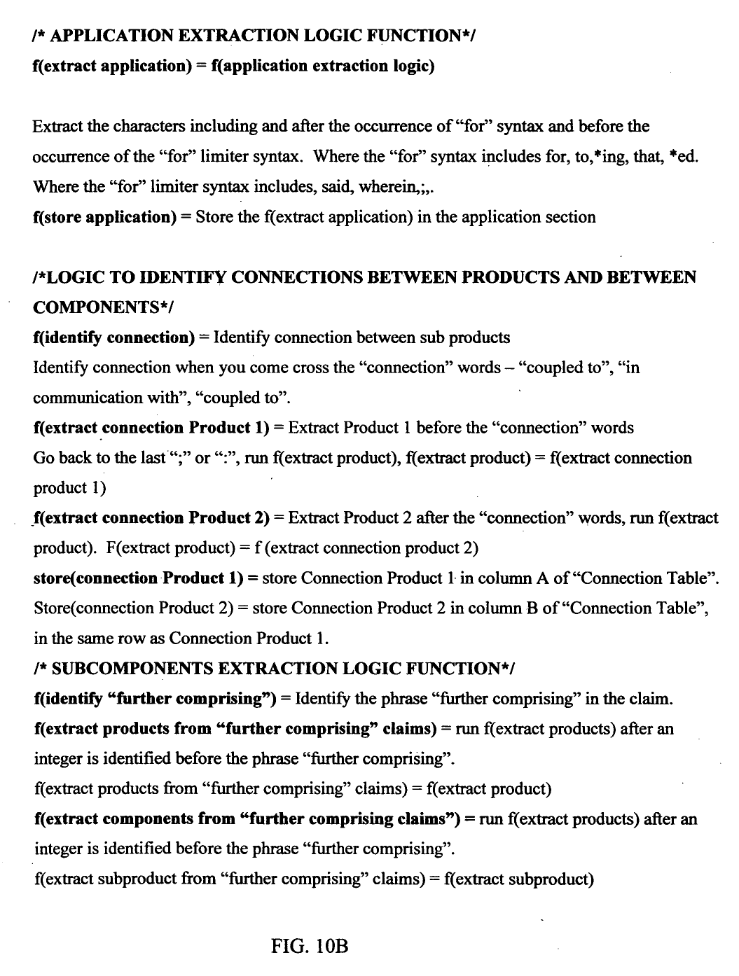

This invention discloses a computer-based method for identifying components and applications to build products and also to identify cross-industry application and marketing of that component or product. The product application design tool is illustrated in FIG. 3 and FIG. 4. Product, component and application extraction logic functions are implemented for the following activities: to differentiate and classify claims into product claims and process claims; segment a product claim into a product, component and application sections; and extract product, component and their application information. The logic steps to accomplish these activities are illustrated in FIG. 10A and FIG. 10B.

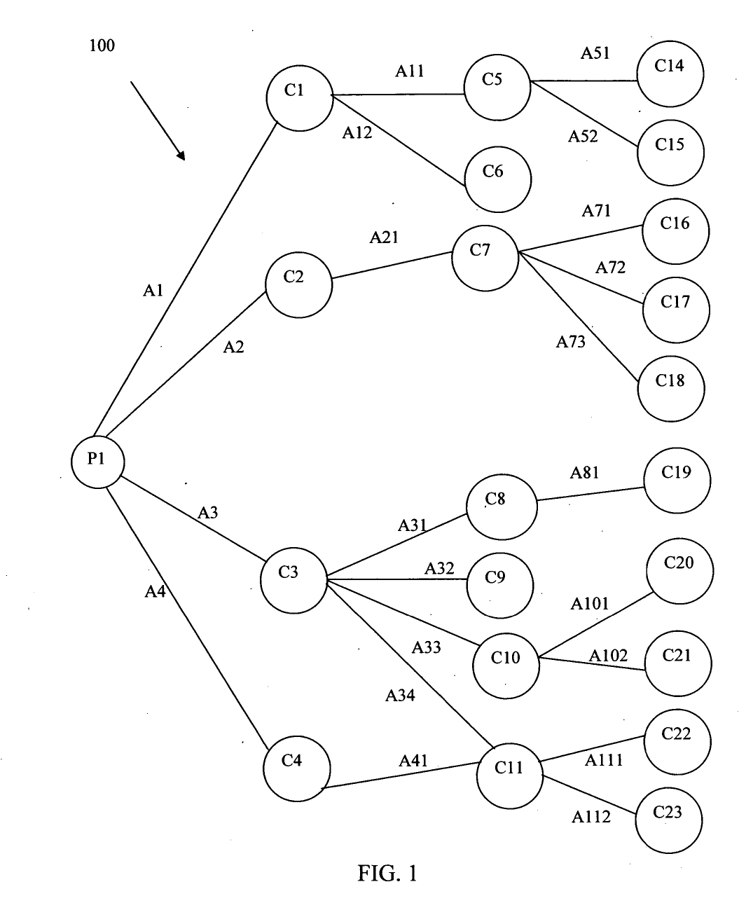

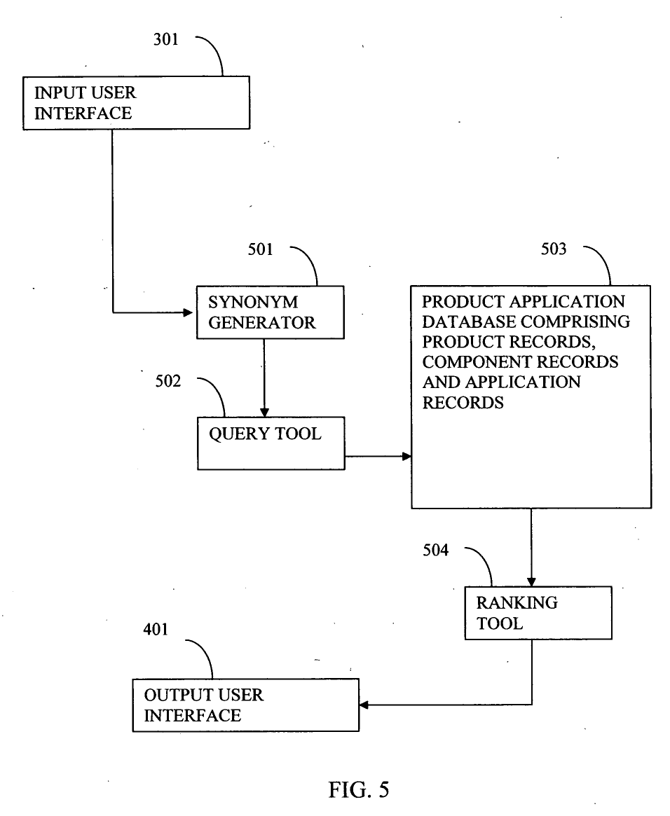

The product application database (PAD) comprises products linked to their components through the component's applications. A product application database (PAD) is populated with the extracted product, component and application information from the patent documents. The product application structure is illustrated in FIG. 1 to conceptually explain how the user can sequentially build such a tree using the product application design (PAD) tool. The extracted product, component and application information does not necessarily have to be stored in the product application database 503, FIG. 5 in the form of a tree structure as shown in FIG. 1, but may be stored in the product application database 503 with no predetermined schema.

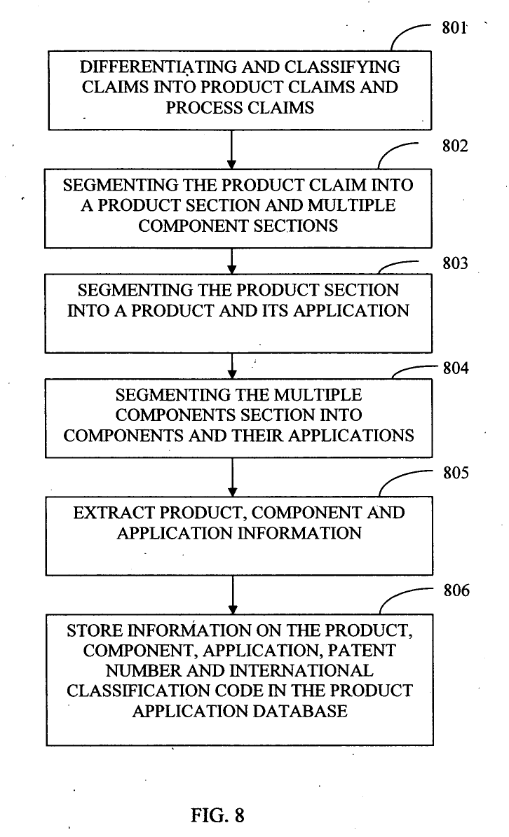

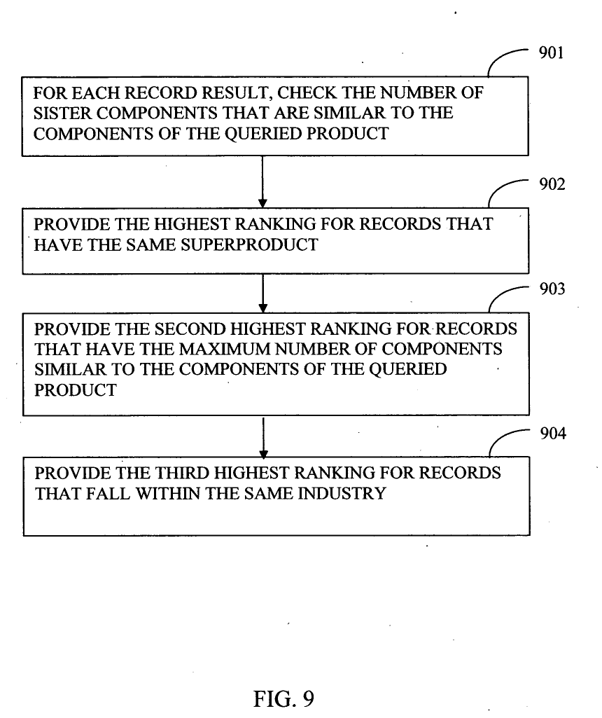

The method of searching the product application database and ranking the resulting records is also shown in FIG. 10A and FIG. 10B. The method of determining a set of records containing product, component and application information is shown in FIG. 8. The method of ranking product, component and results is displayed in FIG. 9.

FIG. 1 illustrates a conceptual tree for the relationship between products, components and applications. Assume that product P1 is comprised of components C1, C2, C3 and C4. Each of the components C1, C2, C3 and C4 serves an application A1, A2, A3 and A4 respectively. For example, consider the following claim of a hypothetical Patent 123456 of inventor John Smith and assigned to ABC Company:
A kitchen table comprising:
   a plastic sheet for supporting utensils and food items;
   wooden legs for supporting said plastic sheet;
   polyvinyl plastic pads placed at the bottom of said wooden legs to prevent the floor from getting scratched; and
   screws for attaching the plastic sheet to the wooden legs.

In this example, the product P1 is a “kitchen table”. The components C1, C2, C3 and C4 are “a plastic sheet”, “wooden legs”, “polyvinyl pad” and “screws” respectively. The applications A1, A2, A3 and A4 are “supporting utensils and food items”, “supporting legs”, “to prevent the floor from getting scratched” and “for attaching the plastic sheet to the wooden legs” respectively.

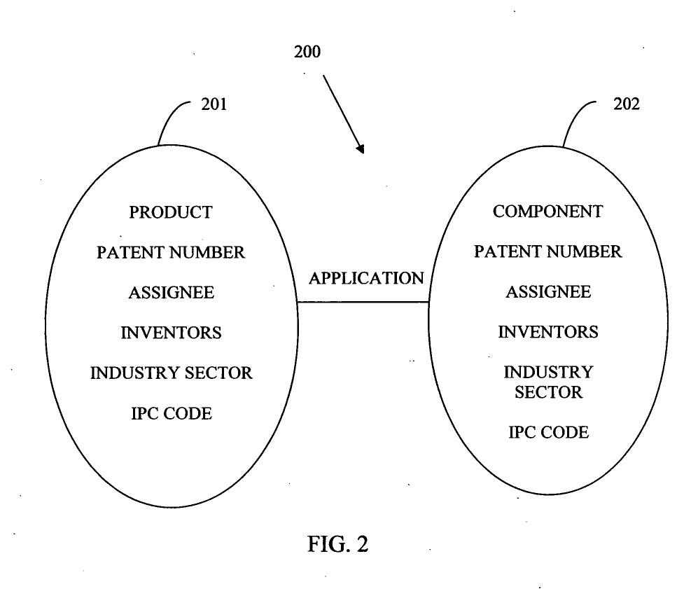

200, FIG. 2 describes the content of each node of the conceptual tree of products, components and applications. The node represents a product or a component. A node is a “product” for components that follow it, and is a “component” for the products or components that precede it. Each circle in FIG. 2 represents a node. In a patent, an “integer” is the number of an independent claim. The “product” 201 is the text after the integer and before the occurrence of product syntax flags such as “for” and “to”. It is possible that in another patent, the product could be a component of another product. Hence, the conceptual tree products, components and applications grow in two directions—in the direction of a product, and in the direction of components that comprise the product. The patent number, assignee, inventor, industry sector and the International Patent Classification of product 201 are also extracted from patent documents and the information is stored in the nodes of the product application. The right hand side of node 201 contains “component” 202, which is the text after the integer signifying the number of the claim and before the occurrence of component syntax flags such as “for” and “to”. Both nodes 201 and 202 are connected through the “application” 200. The “application” is the text after the occurrence of application syntax flags such as “for” and “to” and before the “;” in the claims.

The details of the logic used for extraction of product, component and application information from the claims of patent documents shown in FIG. 10 A is described later in this patent application. The data extracted is stored in the product application database 503, FIG. 5 as records with no predetermined schema. A record comprises a product, component, application and patent bibliographic information. All the instances of a specific record are collected and stored together as a record type. These record types are the equivalent of tables in a relational database model, with the individual records being the equivalent of rows.

This invention provides the user with a product application design (PAD) software tool, hereafter called the PAD tool. At a minimum, the product application design (PAD) tool will have four embodiments. In the first embodiment, the product application design (PAD) tool can accessed via the internet. This embodiment contains a database of relevant product application information from patents, but does not contain a database of patents. In the second embodiment, the product application design (PAD) tool can be accessed via the internet and contains a database of patents. In the third embodiment, the product application design (PAD) tool contains a database of relevant product application information from patents, but is not web enabled. In the fourth embodiment, the product application design (PAD) tool contains a database of patents, but is not web enabled.

FIG. 3 illustrates the input user interface of the product application design (PAD) tool. Consider an example where a designer is designing a movable container apparatus. Assume that the designer has already designed the container component, but would like to identify and evaluate all the components that may be used to enable the “movable” application of the container. FIG. 3 contains three fields. The field in the left column describes the product; the field in the center column describes the component; and the field in the right column describes the application. When conducting a search for a component, product or an application, the user needs to enter information in at least one of the three columns to find information in the columns not filled in. For example, in FIG. 3, the user needs to enter information in either a Component field or the Application field to find a corresponding component, product or application that meets the requirement of the field filled in by the user. Again, for example, by filling in either a Product field or a Component field, a search for the corresponding application of the component or product is performed. A question mark is typed in one of the product, component or application fields to signify the unmet requirement that needs to be determined. By filling in the remaining fields, the user can benefit from a prioritized set of results. The remaining fields define the boundary conditions, industry focus, related products, components and applications that limit and prioritize the results.

Optionally, the user can specify the class or category of industries in which the component, product or applications may be found or located. The product, component or application requirements are specifically entered in the input user interface 301, FIG. 3. Then the available product, component and application information is filled in. The “Add Components” button, FIG. 3 is then clicked to include additional components and their applications. If information for a field is not available, no data is entered in that field. A question mark is then entered in the field that needs to be searched. For example, in FIG. 3, a question mark is placed in the component field for the application of a “movable container unit”. In this example, the user inputs the available information in FIG. 3 of the known structure of the apparatus, i.e., inputs “movable container unit” as product, “transporting materials” as application of the product, “any” as industry focus to search for any container with legs for supporting the container.

When the “Search” button on the above input user interface 301 is clicked, the output user interface 401, FIG. 4 is displayed. Available component options that were identified by the search are listed in the “Components” column of the output user interface 401. When the product application design (PAD) tool was used for the search shown in FIG. 3, twenty-two different component options were identified. For purposes of simplification, only four component results have been presented in FIG. 4. This search identified other possible “component applications” that address the movable container application, such as roller balls, wheels and a conveyor assembly displayed in the “Component Application” column of the output user interface illustrated in FIG. 4.

FIG. 5 illustrates the first embodiment of the invention. In this embodiment, the product application design (PAD) tool is web enabled. This PAD tool contains a database of relevant records containing product, component and application information stored in a product application database, but it does not contain a database of patents. If the user, for example, a product designer is looking for a component to meet an unsatisfied application need, the user inputs the available information of the incomplete product in the input user interface 301. If the user has already designed the product but is looking to find other cross-industry applications of the product or its components, the user inputs the available product and component data in the input user interface 301 shown in FIG. 3.

The synonym generator 501 shown in FIG. 5 generates synonyms for the words submitted by the user in the input user interface 301. The query tool 502 extracts the target information from the product application database 503 and provides a ranked list of solutions. The ranked list of solutions 504 is displayed to the user at the output user interface 401.

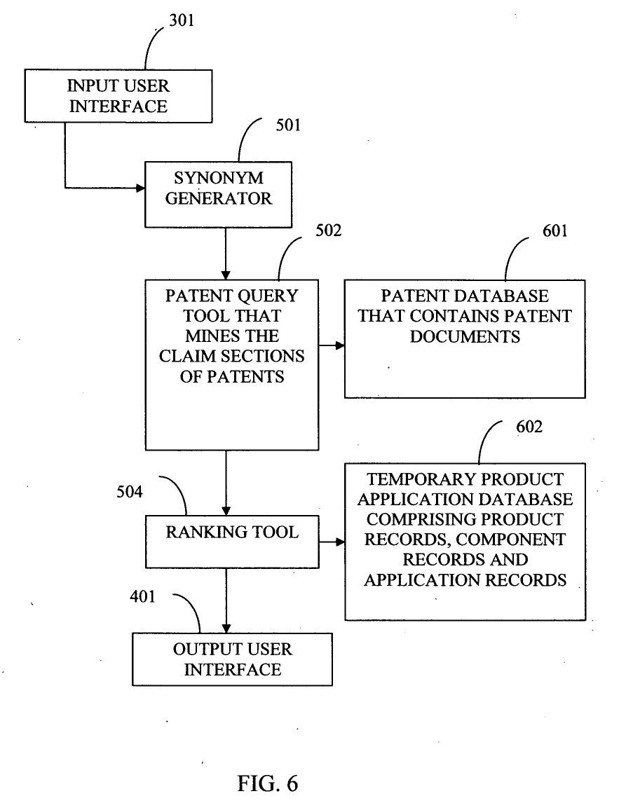

FIG. 6 illustrates a second embodiment of the structure of the Product Application Design Tool (PAD). The PAD tool in the second embodiment is web enabled and contains a database of patents. When the user conducts a search, the patent query tool 502 searches the claims section of all the patents in the patent database 601. The input user interface 301 is hosted on an internet website. The patent database 601, synonym generator 501, patent query tool 502 and ranking tool 504 are located on an internet server. Consider the case where the user is conducting a search for a component that addresses a particular application. Information on the application, keyed in through the input user interface 301, forms the basis of the search conducted in the claim section of the patents stored in the patent database. If the claim of a patent document contains the application keywords, or synonyms of the application keywords, the product, component and application information is extracted and temporarily stored as records of a temporary product application database 602. Hence, each record extracted from the patent database will contain the product, components, sub-components if any, application of the product, application of the component and application of the sub components, assignee name, inventor name and patent number. The ranking tool 504 then ranks the extracted records to provide a prioritized set of results that is displayed on the output user interface 401, FIG. 5.

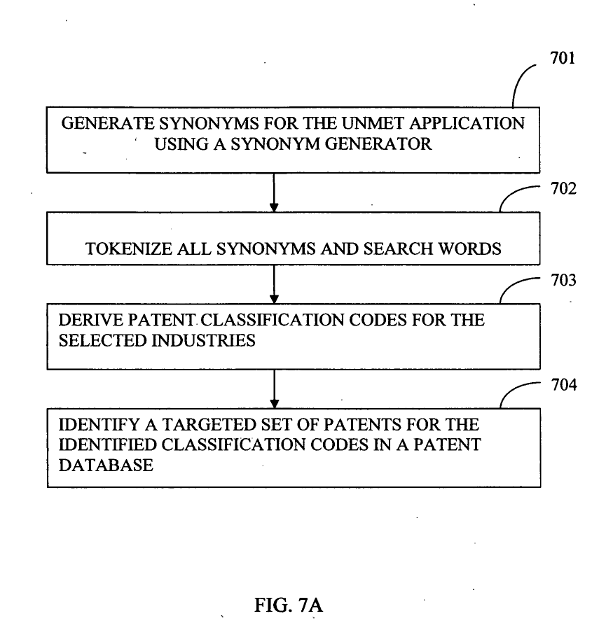

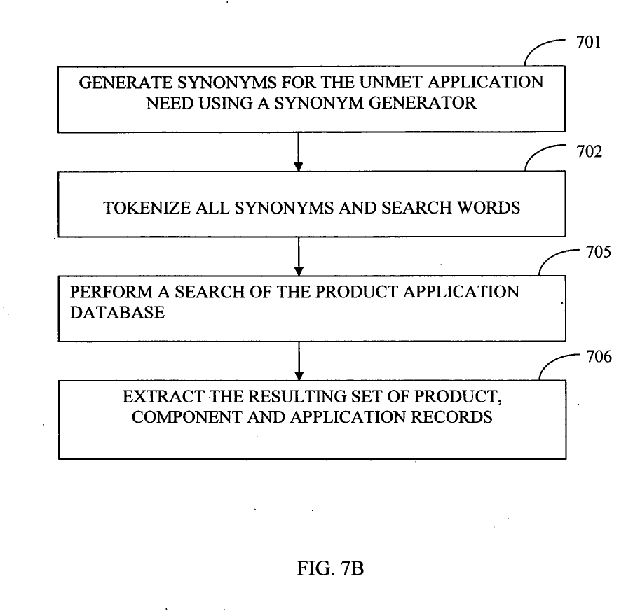

FIG. 7A illustrates a method of conducting a search using the product application design (PAD) tool illustrated in FIG. 6. The PAD tool of FIG. 6 contains a patent database. When the user enters a search for a product, component or application, the synonym generator 501 generates different synonyms for the application 701. The synonyms generated are tokenized 702. The tokenized words are then used to search an international patent classification codes library 703. The classification codes library consists of the international classification codes and description of each classification code. When a relevant international classification code is identified, the claims of all the patents under that international classification code are searched. Only those claims that contain the tokenized words are extracted 704. The results are ranked and displayed on the output user interface 401, FIG. 6.

FIG. 7B illustrates the method of conducting a search using a product application design (PAD) tool illustrated in FIG. 5. The PAD tool illustrated in FIG. 5 contains a patent application database that contains product, component and application data, but does not contain a patent database. When the user enters a search for a product, component or application, the synonym generator 501 generates different synonyms for the application 701, shown in FIG. 7B. The synonyms generated are tokenized 702. The tokenized words are then used to search the product application database that contains product, component and application data 705. The results are extracted 706, ranked and displayed at the output user interface 401.

FIG. 8 illustrates the method of populating the nodes of the product application database. This extraction procedure described in FIG. 7A, FIG. 7B, FIG. 8, FIG. 10A and FIG. 10B creates the product application database (PAD) that contains product, component and application data. The logic used for extraction is detailed in FIG. 10A. The information for the patent application database is extracted from the product claims of patents. The product claims and process claims are first differentiated and segmented 801, 802, 803. The majority of product claims have a standard structure. The first line represents the product with an application, followed by a listing of the components, the components applications and their interconnections. Each product and its application are extracted 804. Similarly, each component and its application are extracted. In addition, the patent number, name of the inventor, name of the assignee and patent classification code is extracted from the patent and is attached to each record containing product, component and application information 805. The extracted information is stored in the product application database 806.

FIG. 9 illustrates the method of ranking the results of a search for products, components or applications. The number of components that match the components of the queried product is counted 901. The matching principle is based on the matching of tokenized components or applications of the queried product with the components or applications of the component of the search result. Component records that have the same product as the queried product are assigned the highest ranking 902. Records that have maximum similarity to the components of the queried product are assigned the second highest ranking 903. Records that fall within the same industry of the queried product are assigned the third highest ranking 904.

FIG. 10A and FIG. 10B illustrate the logic for extracting component and application information from the claims section of patents. f(x) in FIG. 10 represents the software sub-routine that performs the function “x”.

The product, component and application extraction logic functions described in FIG. 10A and FIG. 10B consist of multiple steps. The logic for each step is illustrated under the headings /*LOGIC FOR . . . */ in FIG. 10A and FIG. 10B. In the first step, the logic moves the parser to a specific section of the patent document, for example, to a certain section in the patent claims. In the second step, the product claims and the process claims are differentiated. In the third step, the components are identified and extracted.

The following example explains the logic illustrated in FIG. 10A and FIG. 10B. Consider a patent with the following claim:

What is claimed is:

1. A spread spectrum codeless receiver for reception of direct sequence spread spectrum signals without knowledge of the spreading code therein, comprising:
a quadrature mixer for accepting an input direct sequence spread spectrum signal and a local oscillator signal, for conversion of the baseband signals of the input signal to first and second quadrature signals;
a divider circuit coupled to the oscillator circuit for providing a reference signal divided-down in frequency from the frequency of the local oscillator signal;
a summing circuit coupled to the divider circuit and the multiplier circuit, for combining the Doppler offset signal and the reference signal;
a microchip integrated circuit board comprising of a microprocessor.

The logic steps are illustrated in FIG. 10A. The parser is moved to the claims sections of the patent document. A new parsing operation is started. The claim syntax is identified. The claim syntax includes “I claim:”, “We claim:”, “What is claimed is:”, “We claim”, “Claim” and “Claims”. After the claim syntax, the words are parsed.

Then the product and process claim are differentiated by identifying the presence of the word “method” to classify the claim as a method or a process claim and the non-occurrence of the word “method” to classify the claim as a product claim in the first sentence. The first sentence is defined as the characters between an integer and “:”. In the above example, there is no “method” word occurring in the first sentence between the integer and “:”. Hence, the example represents a product claim.

The following steps illustrate the method of identifying the location of the components of a product in the claims section of the patent document. Go to an integer “i”. Extract all words before the comprising syntax. The “comprising syntax” comprises words or phrases such as “comprising of”, “comprises of”, “comprised of”, “consists of”, “consisting of”, “consisting”, “having”, “including”, “includes”, etc.

In the above example, the extracted section is: “A spread spectrum codeless receiver for reception of direct sequence spread spectrum signals without knowledge of the spreading code therein,”

If the “for” syntax that includes “for”, “to”, words ending with “ed”, “arranged to”, “designed to”, and words ending with “ing”, is present in the sentence before the “comprising syntax”, all the words before the first occurrence of the “for syntax” and after the first occurrence of the “for syntax” is extracted. The word before the “for syntax” as a product and after the “for” syntax and before the “comprising syntax” as the application of the product is stored. If the “for” syntax is not present, all words before the comprising syntax as a product are stored.

In the example above:
the product is “A spread spectrum codeless receiver:”
the product's application is “reception of direct sequence spread spectrum signals without knowledge of the spreading code therein,”

Next, the components and their applications are extracted. After a line break, the lines in which line ends with semicolon or comma are counted. All words before a semicolon or a comma are parsed.

In the example above, the following characters are parsed and extracted:
a quadrature mixer for accepting an input direct sequence spread spectrum signal and a local oscillator signal, for conversion of the baseband signals of the input signal to first and second quadrature signals
a divider circuit coupled to the oscillator circuit for providing a reference signal divided-down in frequency from the frequency of the local oscillator signal
a summing circuit coupled to the divider circuit and the multiplier circuit, for combining the Doppler offset signal and the reference signal
a microchip integrated circuit board comprising a microprocessor.

If “for” syntax is present in the sentence before a comma or a semicolon, all the words before “for” syntax are extracted and stored as a sub-product. If the “for” syntax is not present in the sentence, all words before a semicolon, or a comma, are stored as a sub-product. Lines that start with “means” are ignored. The “means for . . . ” product claims do not identify a product and provide only the application or functionality of the product. Hence, “means for . . . ” product claims are not suitable for extraction.

If “for” syntax is present in the lines before a semicolon or a comma, words after the occurrence of “for” syntax and before the occurrence of “for” limiter syntax are extracted. “For” limiter syntax words such as “includes”, “said” and “wherein” are stored as a sub-product application.

The extraction procedure, applied to the example above, yields the following result:
Component 1 is “a quadrature mixer”
Component 2 is “a divider circuit coupled to the oscillator circuit”
Component 3 is “a summing circuit coupled to the divider circuit and the multiplier circuit,” and
Component 4 is “a microchip integrated circuit board comprising of a microprocessor”.

Application 1 is “accepting an input direct sequence spread spectrum signal and a local oscillator signal, for conversion of the baseband signals of the input signal to first and second quadrature signals”;
Application 2 is “providing a reference signal divided-down in frequency from the frequency of the local oscillator signal”;
Application 3 is “combining the Doppler offset signal and the reference signal”.
Application 4 is “ ”, which indicates no application.

Next, the connection between sub-products is identified. Then the occurrence of the “connection words”, such as “coupled to”, “in communication with” is located. The characters before the “connection” words which, in the example above, is “coupled to” is extracted. Then characters such as Connection Product 1 in column A of the “Connection Table” is stored.

In the example above, Connection Product 1 is the “divider circuit”. The word before the “connection” word, which is “coupled to” is extracted and stored as Connection Product 2 in column B of the “Connection Table” in the same row as Connection Product 1.

In the example above, Connection Product 2 is the “summing circuit”. Then, the phrase “further comprising” in the claim is identified. If “comprising syntax” is present in any sub-product, all the words before “comprising” are extracted and stored as a sub-component. When data is stored, the sub-component is treated as a component. The component that contains the sub-component is treated as a product. In the example above, the subcomponent is “a microprocessor”.

It is intended that all matter contained in the above description and shown in the accompanying drawings be interpreted as illustrative and not in a limiting sense.

What is claimed is:

1. A computer based method of identifying components for a product comprising the steps of:
conducting a search of the claims section of patent documents in a database of patents, further comprising the steps of:
differentiating and classifying claims into product claims and process claims by executing a product extraction logic function in the claims;
segmenting a product claim into a product section and component sections by executing a component extraction logic function in the claims;
segmenting said product section into a product and its application, by executing an application extraction logic function;
segmenting said component section into components and their applications, by executing an application extraction logic function;
extracting product and their application information as product records and extracting the components and their application information;
creating a product application database by populating said product records and component records in a database;
accepting a query from a customer through an input user interface,
wherein the user request comprises information on the known components and known applications and a search request for a desired component or desired application;
identifying a set of product records and component records by conducting a search of said product application database;
ranking said product records and component records; and
displaying the ranked product and component records on an output user interface.

2. A computer based method for identifying components for a particular application, or for identifying applications for a particular component, comprising the steps of:
accepting user requests from a customer through an input user interface, wherein the user request comprises information on the known components and known applications and a search request for an unknown component or unknown application;
conducting a search of the claims section in a patent database, comprising the steps of:
differentiating and classifying claims into product claims and process claims by executing a product extraction logic function in the claims;
segmenting a product claim into a product section and component sections by executing a component extraction logic function in the claims;
segmenting said product section into a product and its application, by executing an application extraction logic function;
segmenting said component section into components and their applications, by executing an application extraction logic function;
extracting product and their application information and extracting the components and their application information as component records;
populating a temporary product application database with said product records and component records;
ranking said product records and component records; and
displaying the ranked product and component records on an output user interface.

3. The computer implemented method of claim 2, wherein the step of accessing user requests includes accessing the input user interface and output user interface through a computer connected to the internet.

4. The computer implemented method of claim 2, wherein the step of creating the product application database further comprises the step of storing the product application database on an internet server.

5. The computer implemented method of claim 1, wherein the step of creating the product application database further comprises the step of storing the product application database on the desktop computer of the user.

6. The computer implemented method of claim 1, wherein the step of creating the product application database further comprises the step of storing the product application database on an internet server.

7. The computer implemented method of claim 2, wherein the step of determining a product record comprises identification of the product, the product's application, the patent number, name of the inventor or inventors, name of the assignee and international patent classification code.

8. The computer implemented method of claim 2, wherein the step of determining a component record comprises determining the component, the component's application, patent number, name of the inventor or inventors, name of the assignee and international patent classification code.

9. The computer implemented method of claim 1, wherein the step of determining a product record comprises determining the product, the product's application, patent number, name of the inventor or inventors, name of the assignee and international patent classification code.

10. The computer implemented method of claim 1, wherein the step of determining a component record comprises determining the component, the component's application, the patent number, name of the inventor or inventors, name of the assignee and international patent classification code.

11. The computer implemented method of claim 2, wherein, the step of determining a set of product records and component records by conducting a search of the product application database comprises the steps of generating synonyms using a synonym generator and tokenizing the generated synonyms.

12. The computer implemented method of claim 1, wherein the step of determining a set of product records and component records by conducting a search of the product application database comprises the steps of generating synonyms using a synonym generator and tokenizing the generated synonyms.

13. The computer implemented method of claim 1, wherein the ranking of said product records and component records comprises the steps of:
counting the number of components that match the components of the queried product, wherein the matching principle is based on a match of tokenized components and tokenized applications of the queried product, with the components and applications of the component of the search result;
providing the component records that have the same product as the queried product with the highest ranking;
providing records that have the maximum similarity to the components of the queried product with the second highest ranking; and
providing records that fall within the same industry of the queried product with the third highest ranking.

14. The computer implemented method of claim 2, wherein the database of patents is located on an internet server.
